(19) United States
(12) Patent Application Publication
(10) Pub. No.: US 2023/0068778 A1
(43) Pub. Date: Mar. 2, 2023

(54) METHOD AND SYSTEM FOR IMPLEMENTING REMAINDER INSTRUCTION OF RISC-V INSTRUCTION SET

(71) Applicant: Guangdong StarFive Technology Co., Ltd., Foshan (CN)

(72) Inventors: Quansheng Liu, Shanghai (CN); Hongbin Yu, Beijing (CN); Lei Liu, Beijing (CN)

(73) Assignee: Guangdong StarFive Technology Co., Ltd., Foshan (CN)

(21) Appl. No.: 17/981,339

(22) Filed: Nov. 4, 2022

Related U.S. Application Data
(63) Continuation of application No. PCT/CN2021/129450, filed on Nov. 9, 2021.

(30) Foreign Application Priority Data
Jan. 18, 2021 (CN) 202110062056.X

(51) Int. Cl. G06F 9/38; G06F 9/30

(52) U.S. Cl. CPC G06F 9/3802; G06F 9/30145; G06F 9/384

(57) ABSTRACT

The invention relates to the technical field of a microprocessor, in particular to a method and a system for realizing the residual instruction of the RISC-V instruction set. The invention executes the CPU out of order, and the instruction enters the instruction decoding unit from the fetch unit to carry out instruction decoding; the instruction after decoding is renamed in the renaming unit, and the remainder instruction is optimized at the same time. If the remainder instruction does not meet the optimization condition, the renamed instruction enters the reservation station and then enters the execution unit for execution; the executed instruction is submitted through the reordering cache and the division instruction encoding cache resources allocated in the renaming phase are released. In the renaming stage, the invention realizes the function of the remainder instruction by adding the residue instruction acceleration unit.

### TECHNICAL FIELD

The invention relates to the technical field of microprocessors, in particular to a method and a system for implementing a remainder instruction of a RISC-V instruction set.

### BACKGROUND TECHNOLOGY

After more than 50 years of development, the architecture of microprocessor has experienced vigorous development along with the semiconductor process. From single core to physical multi-core and logical multi-core; from sequential execution to out-of-order execution; from single launch to multi-launch; especially in the server field, the continuous pursuit of processor performance With the higher and higher requirements of data center and scientific computing, the higher the performance requirements of division and remainder instructions, at the same time, the proportion of division and remainder instructions increases gradually. The execution cycle of division and remainder instructions is relatively long, while the execution cycle is related to data, and the execution cycle is variable. These factors have a great influence on the performance of CPU.

### SUMMARY OF THE INVENTION

In view of the deficiency of the prior art, the invention discloses a method and a system for realizing the residue instruction of the RISC-V instruction set, which is used for solving the execution result that the remainder instruction cannot be executed by the division instruction. Each remainder instruction needs to be executed in the execution unit, and then the remainder is obtained. The remainder instruction has a long execution cycle, resulting in the problem of low efficiency.

The invention is realized through the following technical proposal:

In the first aspect, the invention discloses a method for realizing the remainder instruction of the RISC-V instruction set, which comprises the following steps:

S1 executes the CPU out of order, and the instruction enters the instruction decoding unit from the instruction fetch unit to decode the instruction.

After S2 decoding, the instruction renames the destination register in the renaming unit, and optimizes the remainder instruction.

S3 if the remainder instruction does not meet the optimization conditions, the renamed instruction enters the reservation station and enters the execution unit for execution.

The instruction after S4 execution is submitted by reordering the cache and releases the division instruction encoding cache resources allocated during the renaming phase.

Further, in the method, when the division instruction and the remainder instruction pair occur, the remainder generated by the division instruction is obtained by mapping the destination register of the remainder instruction to the physical register of the write remainder of the division instruction.

Further, in the method, when the remainder instruction occurs in the renaming phase, the coding cache of the division instruction in the residue instruction acceleration unit is retrieved, and if the encoding of the division instruction matches the coding of the remainder instruction, then the remainder instruction can be optimized.

If the coding of the division instruction does not match the encoding of the remainder instruction, then the remainder refers to the need to be executed in the execution unit, and the remainder is calculated.

Further, in the method, the rule for judging that the remainder instruction matching is not successful is that when successive different types of division instructions, consecutive different types of residue instructions, or division instructions do not match the remainder instructions.

When the division instruction and the remainder instruction are judged to be mismatched, the paired field in the remainder instruction acceleration unit is set to 0.

Further, in the method, when the division instruction is written to the division instruction coding cache, it is necessary to judge whether there is an idle entry, and write the information of the division instruction to the corresponding entry; When the identification rem_val of the remainder instruction is valid, it indicates that the current instruction is a remainder instruction, and if the significant bit valid is valid, then the remainder instruction matches successfully.

Further, in the method, the division instruction applies for physical registers div_phy_quo and div_phy_rem in the renaming phase for storing the quotient and the remainder of the division instruction, respectively, wherein the div_phy_quo of the division instruction is updated to the division instruction destination register rename mapping table RAT, div_phy_rem to store the number of remaining registers PHY_REG stored in the division instruction coding cache.

Further, in the method, when the division instruction enters the renaming stage, when there is no paired remainder instruction, the division instruction writes the division instruction information into the division instruction coding cache according to the coding, and when the division instruction writes to the cache, first find the free location in the cache. Then the coding DIV_N_OP of the division instruction, the physical register address div_phy_rem of the pairing remainder instruction and the reordering ROB_ID of the division instruction are written to the cache, and the significant bit valid of the division instruction coding cache is set to 1.

When the remainder instruction enters the renaming phase, the remainder instruction encoding REM_N_OP and the division instruction encoding DIV_N_OP are checked according to the pairing rule between the division instruction DIV and the remainder instruction REM. If the remainder instruction comparison hits, the mapping relationship of the destination register rem_rd is mapped to the rem_phy_reg and updated to the destination register rename mapping table RAT, the remainder instruction execution is completed, the update instruction execution completion instruction is updated in the reorder cache, and the division instruction encodes the cache resource.

Further, in the method, when a refresh, reset or subsequent new division instruction or remainder instruction occurs, the physical register applied for by the division instruction is released, and the division instruction encoding cache is released.

When the division instruction is submitted in ROB, the division instruction coding cache is retrieved according to the ROB_ID,ROB_ID of the division instruction obtained from the submission pointer cm_ptr. If the division instruction encoding cache is not released because of an abnormal refresh or branch instruction prediction error refresh, then the position is released when the remainder instruction is paired.

When an instruction is paired with a division instruction being submitted, the paired remainder instruction releases the physical register div_phy_quo, and when there is no pairing between the remainder instruction and the division instruction being submitted, the division instruction releases both the physical register div_phy_quo and the physical register div_phy_rem.

Further, in the method, when a remainder instruction is in the renaming phase and the division instruction coding cache does not have a matching division instruction, the remainder instruction needs to be sent to the instruction execution unit, and the instruction calculates the remainder and updates to the remainder destination register.

In the second aspect, the invention discloses a system for realizing the residual instruction of the RISC-V instruction set. The system is used for executing the realization method of the residual instruction of the RISC-V instruction set described in the first aspect, which comprises a register, an execution unit, a division unit, an instruction decoding unit and an instruction fetching unit.

The beneficial effects of the invention are:

In the renaming stage, the invention realizes the function of the remainder instruction by adding a residue instruction acceleration unit. When the division instruction and the remainder instruction pair appear, the residue instruction does not need to be transmitted to the subsequent division execution unit. Instead, the remainder instruction is mapped to the physical register of the remainder of the division instruction by mapping the destination register of the residue instruction to the physical register of the remainder of the division instruction, and the execution efficiency of the remainder instruction is high.

### DESCRIPTION OF DRAWINGS

In order to more clearly illustrate the technical scheme in the embodiment of the invention or the prior art, the following will briefly introduce the drawings that need to be used in the embodiment or the prior art description, obviously, the drawings described below are only some embodiments of the invention, and for ordinary technicians in the art, other drawings can be obtained according to these drawings without creative work.

FIG. 1 is the architecture diagram of the implementation of remainder instructions.

FIG. 2 is a diagram of the remainder instruction acceleration processing unit.

FIG. 3 is a diagram of performing division instructions.

FIG. 4 is a graph adjacent to division and remainder instructions.

FIG. 5 is a non-adjacent graph of division and remainder instruction pairing.

FIG. 6 shows the difference between the division instruction and the remainder instruction.

FIG. 7 is a check diagram for the pairing of division instructions and remainder instructions.

### DETAILED DESCRIPTION

In order to make the purpose, technical scheme and advantages of the embodiment of the invention more clear, the technical scheme in the embodiment of the invention will be described clearly and completely in combination with the drawings in the embodiment of the invention. Obviously, the described embodiments are some embodiments of the invention, not all embodiments. Based on the embodiments of the invention, all other embodiments obtained by ordinary technicians in the field without creative work fall within the scope of the protection of the invention.

Embodiment 1

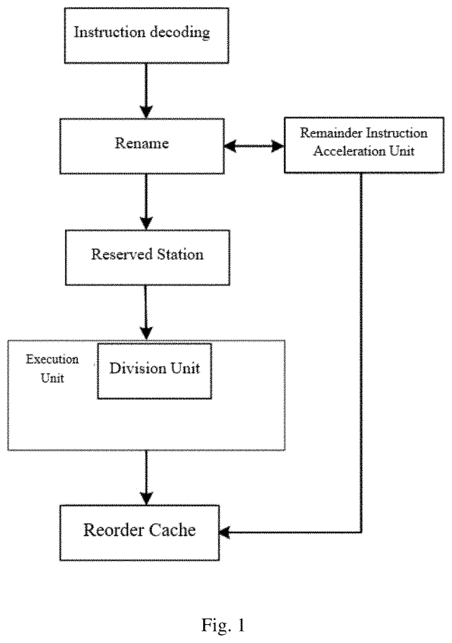

The present embodiment discloses a new method for realizing the remainder instruction. In the renaming phase, the method realizes the function of the remainder instruction by adding a remainder instruction acceleration unit, as shown in FIG. 1. When the division instruction and the remainder instruction pair appear, the remainder instruction does not need to be transmitted to the subsequent division execution unit, but the remainder generated by the division instruction is obtained by mapping the destination register of the remainder instruction to the physical register of the write remainder of the division instruction.

This embodiment takes a specific RISC V instruction as an example to elaborate. In the CPU executed out of order, the instruction enters the instruction decoding unit from the fetch unit to decode the instruction; the instruction after decoding is renamed in the renaming unit to rename the destination register, and the remainder instruction is optimized in the renaming stage; if the remainder instruction does not meet the optimization condition, the renamed instruction enters the reservation station and then enters the execution unit.

The present embodiment mainly focuses on the division instruction and the remainder instruction; the completed instruction is submitted through the reordering cache, and resources such as the division instruction coding cache allocated in the renaming phase are released, as shown in FIG. 1.

The embodiment solves the problem that the remainder instruction can not be executed with the division instruction, each remainder instruction needs to be executed in the execution unit, and then the remainder is obtained, and the remainder instruction has a long execution cycle, resulting in low efficiency.

Embodiment 2

In this embodiment, a new operation code N_OP of the division instruction and the remainder instruction is generated in the instruction decoding stage. For convenience of description, the N_OP of the division and remainder instruction is coded, as shown in Table 1.

TABLE 1
Divide and remainder instruction encoding

| | Extended opcodes | Extended opcodes | | New code |
|---|---|---|---|---|
| Instruction | [31:25] | [14:12] | Opcode | N_OP |
| DIV | 0000001 | 100 | 0110011 | 000 |
| DIVU | 0000001 | 101 | 0110011 | 001 |
| DIVUW | 0000001 | 101 | 0111011 | 010 |
| DIVW | 0000001 | 100 | 0111011 | 011 |
| REM | 0000001 | 110 | 0110011 | 100 |
| REMU | 0000001 | 111 | 0110011 | 101 |
| REMUW | 0000001 | 111 | 0111011 | 110 |
| REMW | 0000001 | 110 | 0111011 | 111 |

In the present embodiment, the instructions in Table 1 are mainly taken as an example. The combinations of division instructions and remainder instructions that can be paired are: 100001 and 101010 and 11011 and 11111. The encoding of the division instruction in N_OP is called DIV_N_OP; the encoding of the remainder instruction in N_OP is called REM_N_OP.

In the present embodiment, when the remainder instruction occurs in the renaming phase, the division instruction encoding cache in the residue instruction acceleration unit is retrieved, and if the DIV_N_OP and REM_N_OP match successfully, then the remainder instruction can be optimized. If the DIV_N_OP and REM_N_OP do not match, then the remainder means that the remainder needs to be executed in the execution unit and the remainder is calculated. The rule for judging that the remainder instruction matching is not successful: when successive different types of division instructions, consecutive different types of residue instructions, or division instructions do not match the remainder instructions. When the division instruction and the remainder instruction are judged to be mismatched, the paired field in the remainder instruction acceleration unit is set to 0.

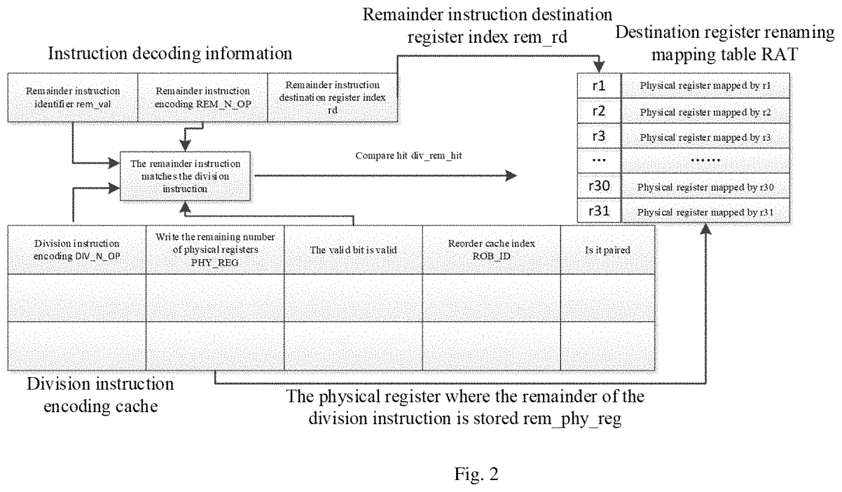

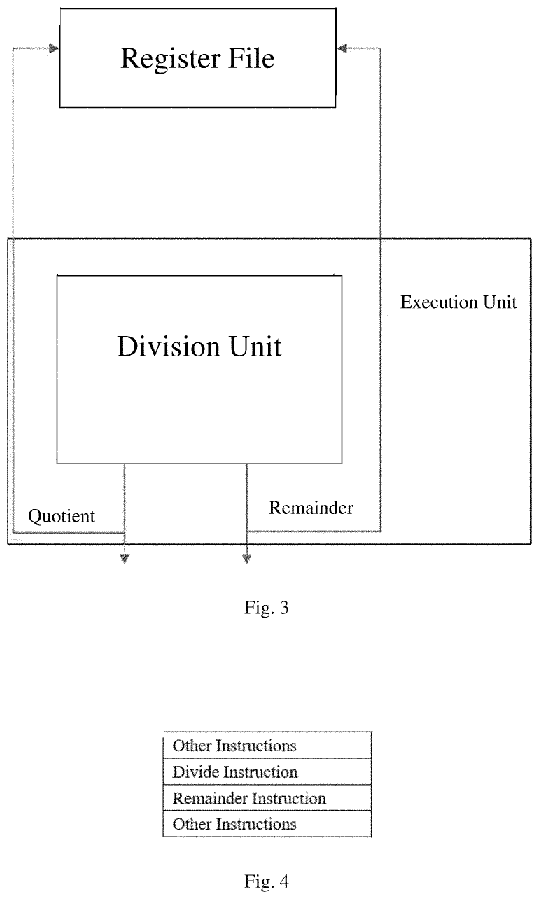

In the present embodiment, the division instruction applies for two physical registers div_phy_quo and div_phy_rem during the renaming phase. These two physical registers store the quotient and remainder of the division instruction, respectively. The div_phy_quo of the division instruction is updated to the division instruction destination register to rename the mapping table RAT. Div_phy_rem the register PHY_REG of the number of writes stored in the division instruction encoding cache. The new encoding N_OP mapped by the division instruction in Table 1 writes to the DIV_N_OP of the division instruction encoding cache. The reorder cache number of the division instruction is also written to the ROB_ID field of the division instruction encoding cache. When the information of the division instruction is written, set valid to valid, as shown in FIG. 2.

In the present embodiment, the division instruction coding cache in the remainder instruction acceleration unit stores the division instructions and related information that need to be paired. When the division instruction is written to the division instruction encoding cache, it is necessary to determine whether there is an idle entry and write the division instruction information to the corresponding entry. When the identification rem_val of the remainder instruction is valid, it means that the current instruction is a remainder instruction. The encoding REM_N_OP of the remainder instruction matches the division instruction encoding DIV_N_OP in the division instruction encoding cache. At the same time, if the significant bit valid is valid, then the remainder instruction matches successfully, that is, div_rem_hit is 1. The remainder instruction destination register rem_rd is mapped to the division physical register rem_phy_reg.

In the present embodiment, when the division instruction enters the division execution unit, both the quotient and the remainder are obtained. In addition to Forward the quotient and remainder to the early wake-up logic, write the quotient and remainder to the physical register stack. The addresses are div_phy_quo and div_phy_rem respectively. When there is a dependency on the division instruction in the reservation station, by comparing div_phy_quo and div_phy_rem, if the physical register address matches, the data is obtained in advance and transmitted to the execution unit for execution.

Embodiment 3

The present embodiment discloses several cases in which the division instruction and the remainder instruction are realized: in the first case, the division instruction and the remainder instruction are paired and are in the same beat pipeline:

In the renaming phase, if there is a pairing between the division instruction and the remainder instruction in the pipeline, and there is no other instruction between the division instruction and the remainder instruction, then the remainder instruction in the pairing instruction does not need to be executed, that is, the remainder instruction does not need to be sent to the subsequent pipeline, and the function of the remainder instruction is completely realized by the paired division instruction, that is, as shown in FIG. 4, the adjacent division instruction and the remainder instruction.

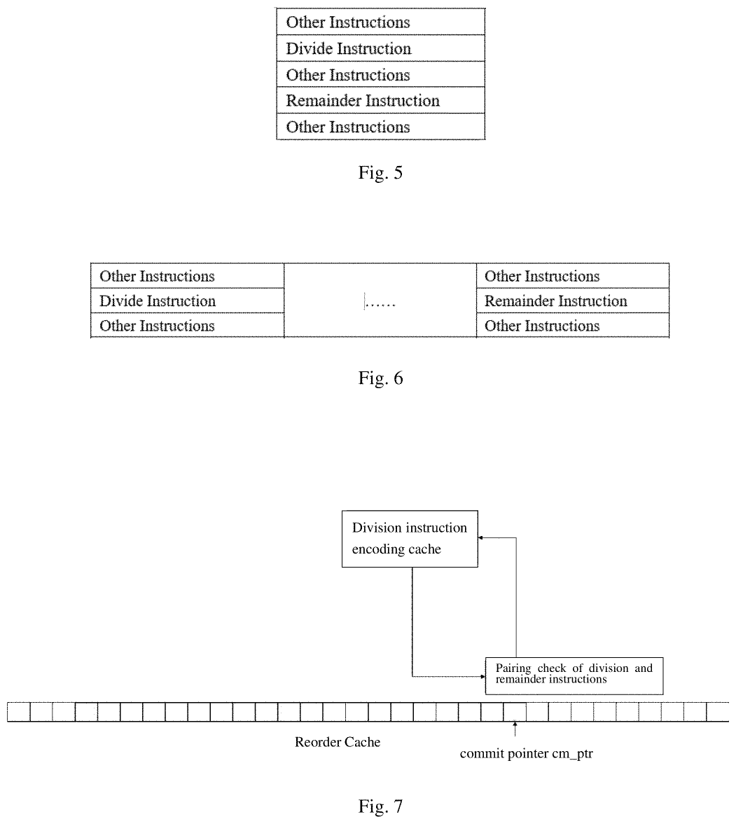

In the renaming phase, if there is a pairing between the division instruction and the remainder instruction in the pipeline, but there are other instructions between the division instruction and the remainder instruction, then the remainder instruction in the pairing instruction does not need to be executed, that is, the remainder instruction does not need to be sent to the subsequent pipeline, and the function of the remainder instruction is fully realized by the paired division instruction, that is, as shown in FIG. 5, the paired but not adjacent division instruction and the remainder instruction.

In the second case, the division instruction is paired with the remainder instruction, but not on the same beat pipeline:

When the division instruction enters the renaming stage, when there is no paired remainder instruction, the division instruction writes the division instruction information into the division instruction coding cache according to the coding in Table 1. When the division instruction writes to the cache, it first finds a free position in the cache, and then writes the coding DIV_N_OP of the division instruction, the physical register address div_phy_rem that stores the result of the pairing remainder instruction, and the reorder ROB_ID of the division instruction to the cache. The significant bit valid of the division instruction encoding cache is set to 1.

When the remainder instruction enters the renaming phase, the remainder instruction encoding REM_N_OP and the division instruction encoding DIV_N_OP are matched to check. Check according to the pairing rule of the division instruction DIV and the remainder instruction REM in Table 1. If the remainder instruction is relatively hit, that is, div_rem_hit is 1, it means that the remainder required by the remainder instruction can be generated by the previous division instruction, and the remainder is saved in rem_phy_reg. Therefore, the remainder instruction only needs to map the mapping of the destination register rem_rd to rem_phy_reg and update it to the destination register rename mapping table RAT. The execution of the remainder instruction is completed, it does not need to enter the subsequent execution unit, it only needs to update the instruction execution completion instruction in the reorder cache, and release the division instruction encoding cache resources, that is, set the valid to 0, as shown in FIG. 2. The remainder instruction releases the physical register when the reorder cache is submitted.

In the third case, the division instruction and the remainder instruction are not matched:

The division instruction itself cannot determine whether it can be paired with the subsequent remainder instruction, so the division instruction in the renaming phase applies for a physical register for the remainder conjecture. When a refresh, reset or subsequent new division instruction or remainder instruction occurs, the physical register applied for by the division instruction is released, and the division instruction coding cache is released.

When the division instruction is submitted at ROB, the division instruction encoding cache is retrieved according to the ROB_ID,ROB_ID of the division instruction obtained from the submission pointer cm_ptr, as shown in FIG. 7. If the division instruction encoding cache is not released because of an exception refresh or branch instruction prediction error refresh, then the position is released when the remaining instructions are paired. When an instruction is paired with the division instruction being submitted, the division instruction does not need to release the physical register div_phy_rem, only the physical register div_phy_quo. The paired remainder instruction releases the physical register div_phy_quo. When there is no pairing between the remainder instruction and the division instruction being submitted, the division instruction needs to release both the physical register div_phy_quo and the physical register div_phy_rem.

In the fourth case, there is no pairing between the division instruction and the remainder instruction, and there is only one remainder instruction:

When a remainder instruction is in the renaming stage and the division instruction coding cache does not have a matching division instruction, the remainder instruction needs to be sent to the instruction execution unit, and the instruction calculates the remainder and updates it to the remainder destination register. In this case, the remainder instruction has exactly the same processing flow as other instructions.

In order to further explain the principle, it is assumed that the bandwidth of CPU is one instruction per clock cycle, and the RISC V instruction sequence in the following table is taken as an example.

TABLE 1
RISC V instruction sequence

| | | Instruction | Supplementary |
|---|---|---|---|
| No. | Instruction | Operands | Instructions |
| 1 | divw | a4, s10, s6 | Division instruction, |
| | | | encoded as 011 |
| 2 | sd | a4, −300(s0) | |
| 3 | sw | a4, −200(s0) | |
| 4 | auipc | a4, 0x1 | |
| 5 | lbu | a5, 1731(a4) | |
| 6 | divu | a5, a5, a4 | Division instruction, |
| | | | encoded as 001 |
| 7 | c.addi | a3, 4 | |
| 8 | addiw | s10, s5, 1 | |
| 9 | remu | s3, a5, a4 | Remainder instruction, |
| | | | encoded as 101 |
| 10 | sw | s3, −4(a3) | |
| 11 | bgeu | a5, a4, pc −20 | |
| 12 | bge | s10, s9, pc +18 | |
| 13 | slli | s8, s5, 2 | |
| 14 | c.ld | a5, 0(a1) | |
| 15 | c.li | a4, 10 | |
| 16 | remu | s3, a5, a4 | Remainder instruction, |
| | | | encoded as 101 |
| 17 | c.addiw | s8, 0 | |
| 18 | c.addi4spn | a3, a5, a4 | |
| 19 | c.li | s5, 1 | |
| 20 | c.swsp | s3, 0(sp) | |
| 21 | bgeu | a5, a4, pc +8 | |
| 22 | divuw | a5, a5, a4 | Division instruction, |
| | | | encoded as 010 |
| 23 | c.addi | a3, 4 | |
| 24 | addiw | s10, s5, 1 | |
| 25 | remu | s3, a5, a4 | Remainder instruction, |
| | | | encoded as 101 |
| 26 | sw | s3, −4(a3) | |
| . . . | . . . | . . . | |

TABLE 2
Write No. 1 divw division instruction

| Division | Write the remaining | | | |
|---|---|---|---|---|
| instruction | number of physical | valid | Reorder cache | |
| code DIV_N_OP | register PHY_REG | bit | index ROB_ID | Pairs |
| 011 | div_phy_{——}rem_1 | 1 | ROB_ID_1 | 1 |

The No. 1 divw division instruction applies for two physical registers div_phy_quo_1 and div_phy_rem_1 when renaming The ROB_ID assigned by the serial number 1 divw instruction is ROB_ID_1. And write this information to the division instruction encoding cache. At the same time, it defaults that there is a remainder instruction paired with the division instruction, that is, whether the field of pairing is set to 1. From the instruction with No. 1 to the instruction with sequence number 6, there is no remainder instruction REMW paired with divw. When the ordinal 1 divw division instruction is submitted in ROB, both the physical registers div_phy_quo_1 and div_phy_rem_1 are released. The No. 6 divu division instruction applies for two physical registers div_phy_quo_2 and iv_phy_rem_2 when renaming The ROB_ID assigned by the serial number 6 divu instruction is ROB_ID_2. And write this information to the division instruction encoding cache. At the same time, whether the matching field of the instruction with sequence number 1 divw is 0, that is, there is no paired remainder instruction in the instruction. The field of pairing corresponding to the sequence number 6 divu division instruction is set to 1.

TABLE 3
Write No. 6 divu division instruction

| Division | Write the remaining | | | |
|---|---|---|---|---|
| instruction | number of physical | valid | Reorder cache | |
| code DIV_N_OP | register PHY_REG | bit | index ROB_ID | Pairs |
| 011 | div_phy_rem_1 | 1 | ROB_ID_1 | 0 |
| 001 | div_phy_rem_2 | 1 | ROB_ID_2 | 1 |

When the No. 9 remu remainder instruction is renamed, it will be found that there is a paired division instruction in the division instruction encoding cache, that is, the divu instruction with ordinal number 6. At this time, the remu remainder instruction with sequence number 9 is decoded into a MOV instruction, which maps the physical register div_phy_rem_2 allocated by the pairing division instruction to the destination register of the sequence number 9 remu remainder instruction. The sequence number 9 remu remainder instruction does not need to be executed by the transmission to the division execution unit. Frees the resource in the division instruction encoding cache of the divu instruction with sequence number 6.

TABLE 4
Release No. 6 divu division instruction

| Division | Write the remaining | | | |
|---|---|---|---|---|
| instruction | number of physical | valid | Reorder cache | |
| code DIV_N_OP | register PHY_REG | bit | index ROB_ID | Pairs |
| 011 | div_phy_rem_1 | 1 | ROB_ID_1 | 0 |

When the No. 16 remu remainder instruction is renamed, it is found that there are no paired division instructions in the division instruction encoding cache. At this point, the instruction needs to be transmitted to the division execution unit to calculate the remainder.

The No. 22 divuw division instruction applies for two physical registers div_phy_quo_3 and div_phy_rem_3 when renaming The ROB_ID allocated by the ordinal 22 divuw instruction is ROB_ID_3, and this information is written to the division instruction encoding cache. At the same time, it defaults that there is a remainder instruction paired with the division instruction, that is, whether the field of pairing is set to 1.

TABLE 5
Write No. 22 divuw division instruction

| Division | Write the remaining | | | |
|---|---|---|---|---|
| instruction | number of physical | valid | Reorder cache | |
| code DIV_N_OP | register PHY_REG | bit | index ROB_ID | Pairs |
| 011 | div_phy_rem_1 | 1 | ROB_ID_1 | 0 |
| 010 | div_phy_rem_3 | 1 | ROB_ID_3 | 1 |

When the No. 25 remu remainder instruction is renamed, it is found that there are no paired division instructions in the division instruction encoding cache. At this point, the instruction needs to be transmitted to the division execution unit to calculate the remainder. At the same time, mark whether the pairing of the 22 divuw instruction is 0, that is, there is no paired remainder instruction in the instruction.

TABLE 6
Release No. 22 divuw division instruction

| Division | Write the remaining | | | |
|---|---|---|---|---|
| instruction | number of physical | valid | Reorder cache | |
| code DIV_N_OP | register PHY_REG | bit | index ROB_ID | Pairs |
| 011 | div_phy_rem_1 | 1 | ROB_ID_1 | 0 |
| 010 | div_phy_rem_3 | 1 | ROB_ID_3 | 0 |

Embodiment 4

The embodiment discloses a system for implementing residual instructions of RISC-V instruction set. the system is used for implementing residual instructions of RISC-V instruction set, which comprises a register, an execution unit, a division unit, an instruction decoding unit and an instruction fetching unit.

In the renaming stage, the invention realizes the function of the remainder instruction by adding a residue instruction acceleration unit. When the division instruction and the remainder instruction pair appear, the residue instruction does not need to be transmitted to the subsequent division execution unit. Instead, the remainder instruction is mapped to the physical register of the remainder of the division instruction by mapping the destination register of the residue instruction to the physical register of the remainder of the division instruction, and the execution efficiency of the remainder instruction is high.

The above embodiments are only used to illustrate the technical scheme of the invention, not to limit it; although the invention is described in detail with reference to the aforementioned embodiments, ordinary technicians in the field should understand that they can still modify the technical scheme recorded in the above-mentioned embodiments, or equivalent replacement of some of the technical features. These modifications or replacements do not deviate the essence of the corresponding technical scheme from the spirit and scope of the technical scheme of the embodiments of the present invention.

1-10. (canceled)

11. A method for realizing residual instructions of a RISC-V instruction set, wherein the method comprises the following steps:
step S1: executing a CPU out of order, and an instruction enters an instruction decoding unit from an instruction fetch unit to decode the instruction;
step S2: after decoding, renaming, based on the instruction, a destination register in a renaming unit, and optimizing a remainder instruction;
step S3: if the remainder instruction does not meet optimization conditions, entering the renamed instruction to a reservation station and entering an execution unit for execution; and
step S4: committing the instruction after execution by reordering a cache and releasing division instruction encoding cache resources allocated during the renaming phase in step S2.

12. The method according to claim 11, wherein, when a pair of the division instruction and the remainder instruction appears, the destination register of the remainder instruction is mapped to a physical register of the write remainder of the division instruction, and the remainder generated by the division instruction is obtained.

13. The method according to claim 11, wherein:
when the remainder instruction occurs in the renaming phase of step S2, an encoding cache of the division instruction in a residue instruction acceleration unit is retrieved;
if a coding of the division instruction matches a coding of the remainder instruction, the remainder instruction is optimizable;
if the coding of the division instruction does not match the coding of the remainder instruction, the remainder instruction is to be executed in the execution unit, and the remainder is calculated.

14. The method according to claim 13, wherein when successive different types of division instructions, successive different types of residue instructions or division instructions do not match the remainder instructions, determining that matching of the remainder instruction is unsuccessful; and
when the division instruction and the remainder instruction are determined to be mismatched, a paired field in the remainder instruction acceleration unit is set to 0.

15. The method according to claim 11, further comprising:
when the division instruction is written to the division instruction encoding cache, determining whether there is a free entry and write information of the division instruction to a corresponding entry; and
wherein when an identification rem_val of the remainder instruction is valid, the current instruction is a remainder instruction, and if a significant bit valid is valid, the remainder instruction matches successfully.

16. The method according to claim 11, wherein:
the division instruction applies for physical registers div_phy_quo and div_phy_rem in the renaming phase in step S2 for storing a quotient and a remainder of the division instruction respectively,
wherein the physical register div_phy_quo is updated to a rename mapping table RAT of the destination register; and
the physical register div_phy_rem is stored to the register PHY_REG stored in the division instruction encoding cache.

17. The method according to claim 11, wherein;
when the division instruction enters the renaming phase in step S2, when there is no paired remainder instruction, the division instruction writes the division instruction information into the division instruction encoding cache according to the coding, and when the division instruction writes the cache, a free position is first found from the cache;
then a coding DIV_N_OP of the division instruction, a physical register address div_phy_rem of the paired remainder instruction, and a reorder buffer ROB_ID of the division instruction are written to the cache, and a significant bit valid of the division instruction coding cache is set to 1;
when the remainder instruction enters the renaming phase in step S2, the remainder instruction encoding REM_N_OP and the division instruction encoding DIV_N_OP are checked according to a pairing rule between the division instruction DIV and the remainder instruction REM; and
if a remainder instruction comparison hits, a mapping relationship of the destination register rem_rd is mapped to a rem_phy_reg and updated to a destination register rename mapping table RAT, the remainder instruction execution is completed, the instruction execution completion status is updated in the reorder buffer, and the division instruction encodes the division instruction encoding cache resources.

18. The method according to claim 11, wherein:
when a refresh, reset, or subsequent new division instruction or remainder instruction occurs, a physical register applied for by the division instruction is released, and the division instruction encoding cache is released;
when the division instruction is committed in ROB, the division instruction encoding cache is retrieved according to a ROB_ID, the ROB_ ID of the division instruction being obtained from a commit pointer cm_ptr;
if the division instruction encoding cache is not released because of an abnormal refresh or branch instruction prediction error refresh, then the position is released when the remainder instruction is paired;
when an instruction is paired with a division instruction being committed, the paired remainder instruction releases a physical register div_phy_quo, and when there is no pairing between the remainder instruction and the division instruction being committed, the division instruction releases both the physical register div_phy_quo and a physical register div_phy_rem.

19. The method according to claim 11, wherein when a remainder instruction is in the renaming stage and the division instruction encoding cache does not have a matching division instruction, the remainder instruction is sent to the execution unit, and the remainder instruction calculates the remainder and updates it to a remainder destination register.

20. A system for implementing RISC-V instruction set remainder instructions, the system comprises a register, an execution unit, a division unit, an instruction decoding unit, and an instruction fetch unit, the system being configured to perform a process comprising the steps of:
step S1: executing a CPU out of order, and an instruction enters an instruction decoding unit from an instruction fetch unit to decode the instruction;
step S2: after decoding, renaming, based on the instruction, a destination register in a renaming unit, and optimizing a remainder instruction;
step S3: if the remainder instruction does not meet optimization conditions, entering the renamed instruction to a reservation station and entering an execution unit for execution; and
step S4: committing the instruction after execution by reordering a cache and releasing division instruction encoding cache resources allocated during the renaming phase in step S2.

21. The system according to claim 20, wherein, when a pair of the division instruction and the remainder instruction appears, the destination register of the remainder instruction is mapped to a physical register of the write remainder of the division instruction, and the remainder generated by the division instruction is obtained.

22. The system according to claim 20, wherein:
when the remainder instruction occurs in the renaming phase of step S2, an encoding cache of the division instruction in a residue instruction acceleration unit is retrieved;
if a coding of the division instruction matches a coding of the remainder instruction, the remainder instruction is optimizable;
if the coding of the division instruction does not match the coding of the remainder instruction, the remainder instruction is to be executed in the execution unit, and the remainder is calculated.

23. The system according to claim 22, wherein when successive different types of division instructions, successive different types of residue instructions or division instructions do not match the remainder instructions, determining that matching of the remainder instruction is unsuccessful; and
when the division instruction and the remainder instruction are determined to be mismatched, a paired field in the remainder instruction acceleration unit is set to 0.

24. The system according to claim 20, wherein the process further comprising:
when the division instruction is written to the division instruction encoding cache, determining whether there is a free entry and write information of the division instruction to a corresponding entry; and
wherein when an identification rem_val of the remainder instruction is valid, the current instruction is a remainder instruction, and if a significant bit valid is valid, the remainder instruction matches successfully.

25. The system according to claim 20, wherein:
the division instruction applies for physical registers div_phy_quo and div_phy_rem in the renaming phase in step S2 for storing a quotient and a remainder of the division instruction respectively,
wherein the physical register div_phy_quo is updated to a rename mapping table RAT of the destination register; and
the physical register div_phy_rem is stored to the register PHY_REG stored in the division instruction encoding cache.

26. The system according to claim 20, wherein:
when the division instruction enters the renaming phase in step S2, when there is no paired remainder instruction, the division instruction writes the division instruction information into the division instruction encoding cache according to the coding, and when the division instruction writes the cache, a free position is first found from the cache;
then a coding DIV_N_OP of the division instruction, a physical register address div_phy_rem of the paired remainder instruction, and a reorder buffer ROB_ID of the division instruction are written to the cache, and a significant bit valid of the division instruction coding cache is set to 1;
when the remainder instruction enters the renaming phase in step S2, the remainder instruction encoding REM_N_OP and the division instruction encoding DIV_N_OP are checked according to a pairing rule between the division instruction DIV and the remainder instruction REM; and
if a remainder instruction comparison hits, a mapping relationship of the destination register rem_rd is mapped to a rem_phy_reg and updated to a destination register rename mapping table RAT, the remainder instruction execution is completed, the instruction execution completion status is updated in the reorder buffer, and the division instruction encodes the division instruction encoding cache resources.

27. The system according to claim 20, Therein:
when a refresh, reset, or subsequent new division instruction or remainder instruction occurs, a physical register applied for by the division instruction is released, and the division instruction encoding cache is released;
when the division instruction is committed in ROB, the division instruction. encoding cache is retrieved according to a ROB_ID, the ROB_ID of the division instruction being obtained from a commit pointer cm_ptr;
if the division instruction encoding cache is not released because of an abnormal. refresh or branch instruction prediction error refresh, then the position is released when the remainder instruction is paired;
when an instruction is paired with a division instruction being committed, the paired remainder instruction releases a physical register div_phy_quo, and when there is no pairing between the remainder instruction and the division instruction being committed, the division instruction releases both the physical register div_phy_quo and a physical register div_phy_rem.

28. The system according to claim 20, wherein when a remainder instruction is in the renaming stage and the division instruction encoding cache does not have a matching division instruction, the remainder instruction is sent to the execution unit, and the remainder instruction calculates the remainder and updates it to a remainder destination register.
